(19) United States
(12) Patent Application Publication
(10) Pub. No.: US 2011/0265042 A1
(43) Pub. Date: Oct. 27, 2011

(54) PROPERTY SET ALLOCATION FOR USER INTERFACE

(75) Inventor: STEWART WILSON, Blackburn (GB)

(73) Assignee: PROMETHEAN LTD, Blackburn (GB)

(21) Appl. No.: 12/768,376

(22) Filed: Apr. 27, 2010

(51) Int. Cl. G06F 3/048

(52) U.S. Cl. 715/835; 715/810

(57) ABSTRACT

There is disclosed a method of applying properties to one or more objects displayed within a software application, comprising: defining a property set; allocating properties to the property set associated with one or more object types; and applying the property step to said one or more objects, wherein only those properties within the set applicable to an object of that type are applied.

### BACKGROUND TO THE INVENTION

1. Field of the Invention

The invention relates to the provision of a customisable user interface for a computer system.

2. Description of the Related Art

It is well-known in software applications for operating on computer systems to provide functionality to allow the properties of content, such as displayed content, timers, passwords etc, to be edited. For example, in a word processing application, it is possible to select and edit the properties of text, for example to change the colour of text, to change the style, to change the size etc. Thus the properties of content displayed in association with a software application may be edited to control aspects such as their appearance and layout.

In order to enable the editing of such properties, user interfaces offer sets of controls for modifying the properties of currently selected items. Thus typically a user will highlight or select in some other way a portion of information content currently displayed, and then edit the properties of such content by accessing controls, menus, sub-menus etc. provided on the user interface.

Editing the properties of selected content or objects in this way can be time consuming. A user may be required to open a number of different menus and sub-menus in order to apply all the necessary edits to the properties of the selected content.

In the prior art this problem has been partly addressed by providing for the collection of tightly associated properties. For example, a particular font, font size and font style (bold, italic, underline etc.) may be grouped and given an identity. A particular portion of a document content may then be selected, and the associated properties applied by selecting the groups name. Thus, for example, in a word processing application, a menu may provide for a list of text styles, which the user may select from. Selecting a particular text style applies a plurality of different properties to the text.

Whilst this provides some advantages to a user, insofar as that the user does not have to access multiple menus and sub-menus in order to edit multiple properties, a user is limited to applying a set of property types which are associated with an object type.

It is an aim of the invention to provide an improved user interface which addresses one or more of the above-stated problems.

### SUMMARY OF THE INVENTION

In accordance with the invention there is provided a method of applying properties to one or more objects displayed within a software application, comprising: defining a property set; allocating properties to the property set associated with one or more object types; and applying the property step to said one or more objects, wherein only those properties within the set applicable to an object of that type are applied.

The step of allocating properties to the property set may comprise displaying all available properties, and selecting from the displayed property types.

The allocated properties may include properties applicable to a limited set of object types.

The allocated properties may include at least one property associated with a first object type and at least one property associated with a second object type.

The method may further comprise: selecting one or more displayed objects; selecting a property set; and applying the properties of the property set to the one or more objects.

The method may comprise the steps of: determining a selected object type; and applying the properties only if they are associated with the object type.

The method may further comprise the step of displaying an icon for selecting the property set on a user interface.

The allocated properties may be selected from one or more available sets of properties provided by the software application.

In a further aspect the invention provides a method of creating a property set for a software application, comprising: selecting a plurality of properties from all available properties within the software application; and allocating the selected properties to a property set, wherein the property set includes properties associated with different object types.

In a further aspect the invention provides a method of applying properties to an object in a software application, comprising: selecting the object; selecting a property set including a plurality of properties, the properties being associated with more than one object type; and applying the properties to the object only if the property is associated with the object type.

In a further aspect the invention provides a computer system comprising: means for defining a property set; means for allocating properties to the property set associated with one or more object types; and means for applying the property step to the object, wherein only those properties within the set applicable to an object of that type are applied

In a further aspect the invention provides a computer system comprising: means for selecting a plurality of properties from all available properties within the software application; and means for allocating the selected properties to a property set, wherein the property set includes properties associated with different object types.

In a further aspect the invention provides a computer system comprising: means for selecting the object; means for selecting a property set including a plurality of properties, the properties being associated with more than one object type; and means for applying the properties to the object only if the property is associated with the object type.

### BRIEF DESCRIPTION OF THE FIGURES

The invention will now be described by way of example with reference to the accompanying figures in which:

FIG. 1 illustrates an exemplary interactive display system in which embodiments of the invention may be implemented;

FIG. 2 illustrates the selection of properties in a prior art user interface;

FIG. 3 illustrates the grouping of user properties in an example in accordance with the principles of the present invention;

FIG. 4 illustrates the presentation of a graphical user interface in accordance with an example in accordance with the invention;

FIG. 5 illustrates a flow diagram for the creation of a set of customised properties in accordance with an example in accordance with the invention;

FIG. 6 illustrates the application of a set of associated properties collated according to the technique of FIG. 5; and

FIG. 7 illustrates an exemplary computer system architecture identifying the means for implementing embodiments of the invention.

### DESCRIPTION OF THE PREFERRED EMBODIMENTS

The invention is described herein with reference to particular example implementations and embodiments. One skilled in the art will appreciate that the invention is not limited to the specific details of any such implementations or embodiments. in particular, the invention is described herein in the context of application to an interactive display system. The invention is not limited to the specifics of the exemplary interactive display system set forth herein. Further, the invention is not limited in its application to interactive display systems. In general the invention may be applicable in any environment in which a user interface is provided to allow a user to interface with a software application.

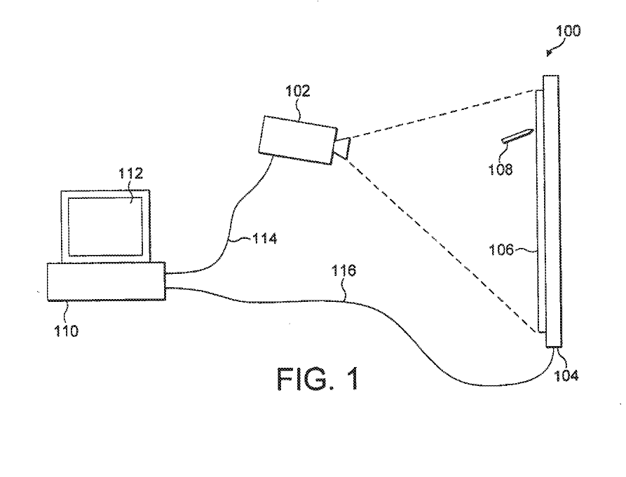

With reference to FIG. 1, there is illustrated an interactive display system 100 within which a graphical user interface adapted in accordance with the principles of the invention may advantageously be used. The interactive display system 100 includes a projector 102, a display board 104 having a display surface 106, a pointer 108, and a computer 110 having an associated display 112. The computer 110 is connected to the projector 102 via a communication link 114, and is connected to the display device 104 by a connection 116.

The operation of interactive display systems such as that illustrated in FIG. 1 are well-known to those skilled in the art. In general, the projector 102 is controlled by the computer 110 to project onto the display surface 106 images. A user uses a pointer 108 to manipulate the images displayed on the display surface 106. For example the user may use the pointer 108 in the way that a mouse of a computer system is used, to move a cursor around. the display surface, and to select objects displayed on the display surface. Although a pointer is illustrated in FIG. 1, in alternative interactive display systems a user's finger may be used to manipulate images on the display surface. In general the pointer 108 may be considered a pointing means, which term encompasses a physical device or a user's finger. The interactive display surface may be a touch-sensitive surface, or any other type of interactive surface. The display device 104 is adapted to operate in combination with the computer system 110 to determine the location of the pointer 108 on the display surface 106, and to determine any actions carried out by the pointer, such as selection of an icon. The computer 110 then updates the displayed image projected through the projector 102 in dependence upon detection of action of the pointer 108.

As one skilled in the art will understand, the selection of properties for content or objects within documents in the prior art requires a user to access controls, dialogs, menus, sub-menus etc. For example, in formatting a text document a user may select text by highlighting a particular portion of text, and once such portion of text is highlighted then access various menus and sub-menus to apply user preferences, such as font type, font size, font colour etc. A similar process is followed for editing other object types, such as drawings or pictures.

It is known in the art that there may be a preconfigured set of properties, which when selected applies multiple different settings to a particular object. In addition in the prior art it is known in text editing software, for example, to provide functionality for a user to define a customised set of properties which can be applied repeatedly to text.

In accordance with the invention, there is provided functionality to enable a user to select one or more properties associated with one or more object types, which may be then stored or saved as a customised property set. When a document or object, or a part of a document or object, is selected, and the property set is selected, the properties within the property set which are associated with that object type are applied to the selected document/object or selected part of the document/object. As such, properties are pre-selected, and then selectively applied based on object type.

In a preferred embodiment, a functionality is provided within a software application which enables a user to select, for display, all available properties within an application for all types of objects. Thus a software application may be provided with a menu option, or displayed icon, which when selected causes all available properties for all objects to be displayed.

From the list of displayed properties, a user is able to select individual property types and allocate them to a group.

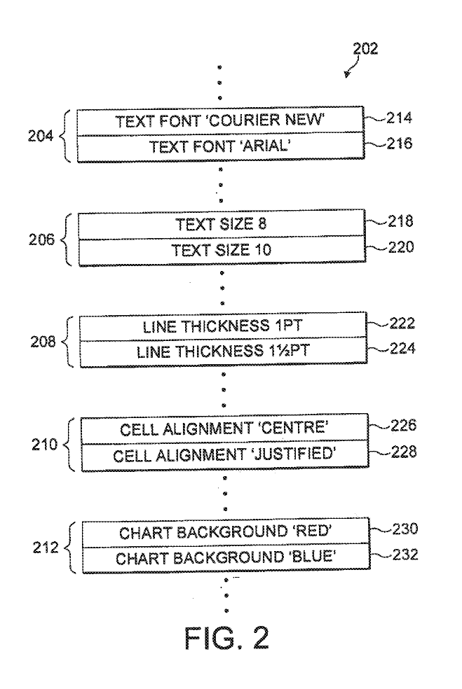

With reference to FIG. 2, there is illustrated in part the display of all properties available within a software application, as denoted. by reference numeral 202. One skilled in the art will appreciate that the full list of properties displayed will be dependent upon the software application being run.

In the example of FIG. 2, the list of properties 202 includes text from types denoted by reference numeral 204, including “courier new” and “arial” denoted by reference numerals 214 and 216. Text sizes are displayed as denoted by reference numeral 206, including size 8 and size 10 as denoted by reference numerals 218 and 220 respectively. Line properties for drawings are displayed as denoted by reference numerals 208, including line thicknesses “1 pt” and “1½pt” denoted by reference numerals 222 and 224. Properties of tables are displayed as denoted by reference numeral 210, including “centre” alignment and “justified” alignment as denoted by reference numerals 226 and 228. Chart properties are displayed as denoted by reference numeral 212, including background colours red and blue denoted by reference numerals 230 and 232. One skilled in the art will appreciate the large number of potential properties which may be displayed in the list 202 in accordance with any given software application.

In accordance with an exemplary embodiment of the invention, the software application is further amended such that on display of the list of properties as illustrated in FIG. 2, the user may select one or more properties and allocate them to a. property set. The selection of the properties may be carried out in a number of ways. For example the user may highlight a particular property and “drag and drop” it into a folder. Alternatively the user may be able to highlight multiple properties, and on selection of further options allocate the highlighted properties to a folder. In general, however, the user is able to select one or more properties from the displayed list, and allocate them to a specific property set. In this way a property set is defined which contains one or more properties from all available properties.

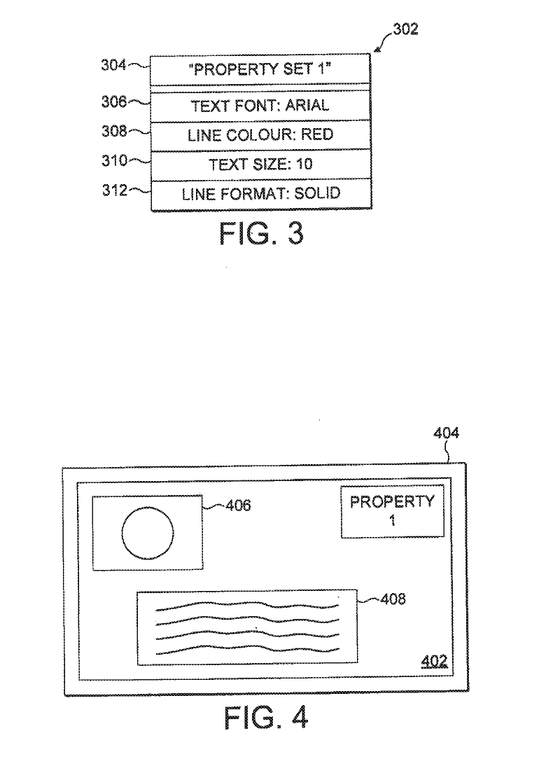

With reference to FIG. 3, there is illustratively shown a property set denoted by reference numeral 302. This property set is labelled “property set 1” in a header portion of a table, denoted by reference numeral 304. Within the table there is then listed all properties chosen by a user for this property set, which in the example of FIG. 3 includes the arial text font as denoted by reference numeral 306, the red line colour as denoted by reference numeral 308, the 10 text size as denoted by reference numeral 310, and the solid line format as denoted by reference numeral 312. One skilled in the art will appreciate that property sets may be more expansive than the example illustrated in FIG. 3. The properties which may be included in a property set are limited only by the properties available within the software application.

As can be seen from the example of FIG. 3, the property set includes properties which are limited in their application to particular object types. Thus, for example, the arial text font and the 10 text size are applicable to objects of the text type. The red line colour and the solid line format are applicable to objects of the drawing type. Thus not all properties within a particular property set are applicable to all object types.

In accordance with the invention, and its exemplary embodiments, once a property set has been defined, it may be applied to one or more objects within a document being viewed using a software application. In accordance with the invention and exemplary embodiments thereof, only the properties within a property set which are applicable to a given object type will be applied when selected for application to an object, other properties being ignored.

Thus, considering the example of FIG. 3 further, if a drawing object is selected within a document, and the property set 302 of FIG. 3 selected to be applied to the selected drawing object, only the properties associated with the red line colour and solid line format will be applied. The software application is thus adapted in order to determine which of the properties within a property set are associated with the selected object type, and only apply those properties.

Thus when editing a document, a user may select or highlight a particular portion of the content, and then select a predetermined property set. This may be achieved by displaying an icon on the user interface which denotes the defined property sets, and on selection of this icon properties are applied to the selected or highlighted content or object as appropriate.

The software application is adapted such that only those properties which are applicable to the particular selected or highlighted content or object are applied. Thus if the set of properties includes those associated with an image, but the selected content is text, those properties associated with an image will not be applied.

The collection of properties, with associated values, is named (such as “property set 1”) and preferably represented somewhere in the user interface as an icon, such as a button or menu item, which can be used to quickly assign property values to currently selected items in the document. For example, with reference to FIG. 4, there is illustrated a display 402 of a display device 404, which displays content comprising an image 406, and content comprising text 408. Various user interface icons will be displayed on the display, which are not shown for purposes of clarity, but in addition a user icon 404 is displayed which is associated with property 1. A user may select portions of the text 408, or select the image 406, and then click on the icon 404. Any attributes associated with the property linked to the icon 404 are then applied to either the image 406 or text 408 as appropriate, but only if those attributes are applicable to the appropriate type of content or object. Where a property is not applicable for a certain object type, it is ignored.

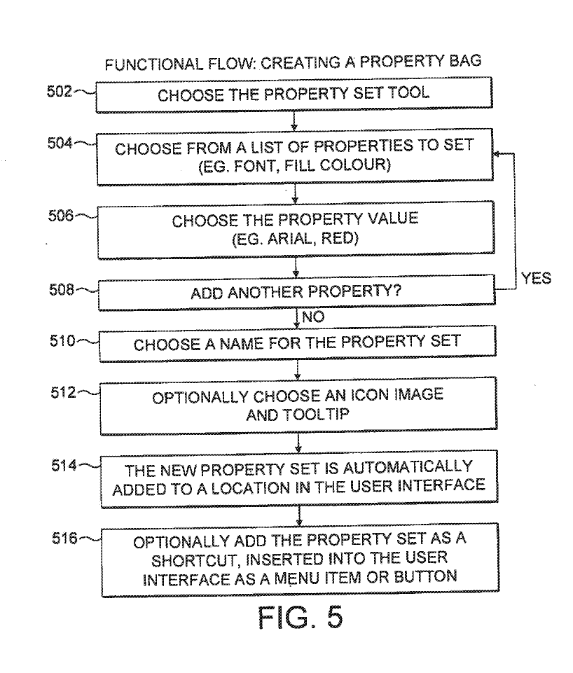

A functional flow illustrating the creation of a property set in a grouped manner is illustrated with respect to FIG. 5.

In a step 502, the “property set” tool is chosen within the software application, or more generally the functionality which allows a property set to be defined is enabled. As a result of such selection, a list of properties is displayed as discussed hereinabove with reference to FIG. 2.

In a step 504, a property is chosen from the list of properties. In an exemplary embodiment, the list of properties may not necessarily be the full list of properties available within the software application, but the categories under which they fall. Thus in the example of FIG. 5 in step 504 a list of property categories is displayed, and then on selection by the user of a particular property category, the properties in that category are displayed and then in a step 506 a property within that property category is selected.

In selecting a property, a property value is also chosen. A default property value may be associated with a property. Alternatively a value may be assigned or given to a property when the property is selected.

One skilled in the art will appreciate that the way in which the properties are displayed and accessed will be implementation dependent, and multiple options are possible.

Following selection of a particular property, in a step 508 it is determined whether another property is to be selected. If so, steps 504 and 506 are repeated. If no further properties are to be selected, then in step 510 a name is chosen for the property set to which the selected properties will be allocated.

In an optional step 512, an icon image and/or tool tip may be chosen for the property set. This would allow, for example, an icon image associated with a particular property set to be displayed on the user interface. A tip associated with the use of the property set may also be associated with the icon image, and for example displayed when the cursor is positioned over the icon image.

In a step 514 following the establishment of the property set, the property set is added, preferably automatically, to a location in the user interface. Alternatively the location of the property set, or an icon associated therewith, may be added to a location in the user interface chosen by the user.

In an optional step 516, the property set may be added to the user interface as a shortcut, or inserted into the user interface as a menu item or button. One skilled in the art will appreciate the options for positioning within the user interface access to the property set.

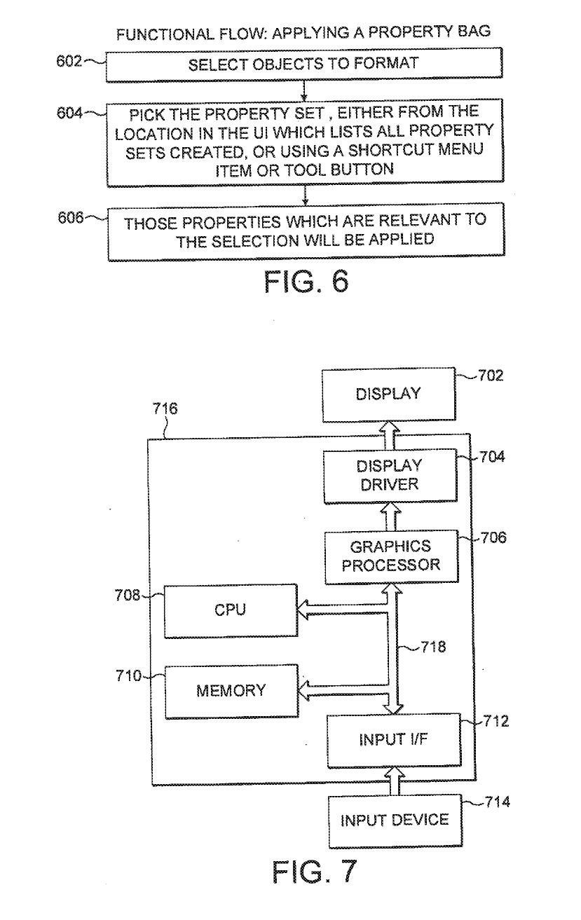

A functional flow illustrating the application of a set of grouped properties is illustrated with reference to FIG. 6.

In step 602, a user selects one or more objects to be formatted or edited.

In a step 604, the user then selects the property set to be applied to the selected objects. The property set may be selected by selecting an appropriate location in the user interface, upon which selection all property sets which have previously been created are listed. Alternatively a shortcut menu or tool button may be selected to allocate a list of property sets. Alternatively a specific property set may be selected by a unique icon or tool button displayed on the user interface.

In a step 606, the properties of the property set which are applicable to the selected object type or types are applied to the selected object or objects.

With reference to FIG. 7, there is illustrated an exemplary computer system architecture including means for implementing embodiments of the invention. The computer system is generally designated by reference numeral 716. The computer system includes a central processor unit (CPU) 708, a memory 710, a graphics processor 706, a display driver 704, and an input interface 712. The graphics processor 706, CPU 708, memory 710, and input interface 712 are interconnected via an interface bus 718. The graphics processor 706 connects to the display driver 704 via a graphics bus 720. The display driver 704 is connected to a display 702 associated with the computer system via an interface 722. The input interface 712 receives input signals on an interface 724 from an input device (or devices) 714.

The display 702 may be integrated with the computer system or be external to the computer system. The display 702 may be, for example, a display of an interactive display system. The input device 714 may be integrated with the computer system or external thereto. The input device 714 may be a pointing device associated with an interactive display surface.

In other exemplary arrangements, the display 702 may be an integrated display of a personal data assistant (PDA) device or other form of portable computer system. The input device 714 may be an integrated keypad of a PDA, a keyboard associated with a computer system, or a touch surface. One skilled in the art will appreciate the possible options for providing inputs to different types of computer system, and for displaying data from different types of computer system.

The methods described hereinabove may be implemented on computer software running on a computer system. The invention may therefore be embodied as computer program code being executed under the control of a processor of a computer system. The computer program code may be stored on a computer program product. The computer program product may include a computer memory, a portable disk or portable storage memory, or hard disk memory.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method of applying properties to one or more objects displayed within a software application, comprising:
defining a property set;
allocating properties to the property set associated with one or more object types; and
applying the property step to said one or more objects, wherein only those properties within the set applicable to an object of that type are applied.

2. A method according to claim 1 wherein the step of allocating properties to the property set comprises displaying all available properties, and selecting from the displayed property types.

3. A method according claim 1 wherein the allocated properties include properties applicable to a limited set of object types.

4. A method according to claim 3 wherein the allocated properties include at least one property associated with a first object type and at least one property associated with a second object type.

5. A method according to claim 1 further comprising:
selecting one or more displayed objects;
selecting a property set; and
applying the properties of the property set to the one or more objects.

6. A method according to claim 5 further comprising the steps of:
determining a selected object type; and
applying the properties only if they are associated with the object type.

7. A method according to claim 1 further comprising the step of displaying an icon for selecting the property set on a user interface.

8. A method according to claim 1 wherein the allocated properties are selected from one or more available sets of properties provided by the software application.

9. A method of creating a property set for a software application, comprising:
selecting a plurality of properties from all available properties within the software application; and
allocating the selected properties to a property set, wherein the property set includes properties associated with different object types.

10. A method of applying properties to an object in a software application, comprising:
selecting the object;
selecting a property set including a plurality of properties, the properties being associated with more than one object type; and
applying the properties to the object only if the property is associated with the object type.

11. A computer program product for storing computer program code which, when executed on a computer system, performs the method of claim 1.

12. A computer program for execution on a computer system to perform the method of claim 1.

13. A computer system comprising:
means for defining a property set;
means for allocating properties to the property set associated with one or more object types; and
means for applying the property step to the object, wherein only those properties within the set applicable to an object of that type are applied

14. A computer system comprising:
means for selecting a plurality of properties from all available properties within the software application; and
means for allocating the selected properties to a property set, wherein the property set includes properties associated with different object types.

15. A computer system comprising:
means for selecting the object;
means for selecting a property set including a plurality of properties, the properties being associated with more than one object type; and
means for applying the properties to the object only if the property is associated with the object type.
